(19) United States
(12) Patent Application Publication
(10) Pub. No.: US 2012/0273561 A1
(43) Pub. Date: Nov. 1, 2012

(54) REINFORCEMENT FOR CONTAINER

(75) Inventors: CYNTHIA A. IRVIN, Battle Ground, WA (US); Dennis A. Bradshaw, Damascus, OR (US); Robert A. Kaszubowski, JR., Maple Grove, MN (US)

(73) Assignee: Adalis Corporation, Vancouver, WA (US)

(21) Appl. No.: 13/097,666

(22) Filed: Apr. 29, 2011

(51) Int. Cl. B65D 5/42; B32B 7/12

(52) U.S. Cl. 229/199; 428/343

(57) ABSTRACT

A container comprising at least one panel or flap configured to at least partially form a bottom or at least one wall of the container, wherein the panel or flap comprises a corrugated paper board, and the panel or flap includes an inside surface and an outside surface; and at least one reinforcing tape or string adhesively affixed to at least one panel or flap of the container, wherein the reinforcing tape or string comprises an adhesive disposed on a substrate, the reinforcing tape or string has a chord modulus of at least 100 grams/denier between 0% and 4% elongation, and the reinforcing tape or string has a width of equal to or less than 10 mm.

### BACKGROUND

The bottom panels of containers made from corrugated paper board tend to deflect over time when the container is loaded with goods. This deflection (known as “bottom sag”) can damage the goods when the loaded containers are stacked upon each other.

### SUMMARY

According to one embodiment disclosed herein there is provided a container comprising:

at least one panel or flap configured to at least partially form a bottom or at least one wall of the container, wherein the panel or flap comprises a corrugated paper board, and the panel or flap includes an inside surface and an outside surface; and

at least one reinforcing tape or string adhesively affixed to at least one panel or flap of the container, wherein the reinforcing tape or string comprises an adhesive disposed on a substrate, the reinforcing tape or string has a chord modulus of at least 100 grams/denier between 0% and 4% elongation, and the reinforcing tape or string has a width of equal to or less than 10 mm.

A further embodiment disclosed is a container comprising:

at least one panel or flap configured to at least partially form a bottom or at least one wall of the container, wherein the panel or flap comprises a corrugated paper board, and the panel or flap includes an inside surface and an outside surface; and

at least one reinforcing tape or string adhesively affixed within the corrugated paper board forming the bottom panel of the container, wherein the reinforcing tape or string comprises a hot melt adhesive disposed on a liquid crystal polymer fibrous material, and the reinforcing tape or string has a chord modulus of at least 200 grams/denier between 0% and 4% elongation.

Also disclosed herein is a reinforced construct, comprising:

a corrugated paper board substrate having a flute direction and comprising at least a first layer and at least a second layer; and

a reinforcing tape or string adhesively secured to at least the first layer or the second layer, wherein the reinforcing tape or string has a longitudinal direction and the reinforcing tape or string is located so that the longitudinal direction of the reinforcing tape or string is perpendicular to the flute direction of the corrugated paper board, wherein the reinforcing tape or string comprises an adhesive disposed on a substrate, the reinforcing tape or string has a chord modulus of at least 100 grams/denier between 0% and 4% elongation, and the reinforcing tape or string has a width of equal to or less than 10 mm.

Another embodiment disclosed herein is a reinforcing tape or string, comprising:

a length of elongate, hot melt adhesive-coated liquid crystal polymer fibrous material, wherein the reinforcing tape or string has a width of equal to or less than 10 mm.

Also disclosed herein is a method for minimizing or preventing sagging of a corrugated paper board bottom panel of a container, wherein the corrugated paper board bottom panel has a flute direction and a length direction that is longer than a width direction, the method comprising:

providing a reinforcing tape or string along the length direction of the corrugated paper board bottom panel and in a longitudinal direction perpendicular to the flute direction of the corrugated paper board bottom panel, wherein the reinforcing tape or string comprises an adhesive disposed on a substrate, the reinforcing tape or string has a chord modulus of at least 200 grams/denier between 0% and 4% elongation, and the reinforcing tape or string has a width of equal to or less than 10 mm.

Another method disclosed herein is directed to a method for minimizing or preventing deflection of a corrugated paper board side wall of a container, wherein the corrugated paper board side wall has a flute direction, the method comprising:

providing a reinforcing tape or string in a longitudinal direction perpendicular to the flute direction of the corrugated paper board side wall, wherein the reinforcing tape or string comprises an adhesive disposed on a substrate, the reinforcing tape or string has a chord modulus of at least 200 grams/denier between 0% and 4% elongation, and the reinforcing tape or string has a width of equal to or less than 10 mm.

The foregoing will become more apparent from the following detailed description, which proceeds with reference to the accompanying figures.

### BRIEF DESCRIPTION OF THE DRAWINGS

FIG. 1 is a perspective view of a corrugated paper board substrate in which a reinforcing tape as disclosed herein is embedded.

FIG. 2 is a plan view of one embodiment of a container blank that includes two reinforcing tapes as disclosed herein located on, or within, the length side flaps.

FIG. 3 is a perspective view of a container made from the blank of FIG. 2.

FIG. 4 is a plan view of another embodiment of a container blank that includes a single reinforcing tape as disclosed herein located on, or within, the bottom panel.

FIG. 5 is a perspective view of a container made from the blank of FIG. 4.

FIG. 6 is a plan view of a further embodiment of a container blank that includes three reinforcing tapes as disclosed herein. Two of the reinforcing tapes are located on, or within, the length side flaps, and one of the reinforcing tapes is located on, or within, the bottom panel.

FIG. 7 is a perspective view of a container made from the blank of FIG. 6.

FIG. 8 is a table reporting bottom sag resistance test results.

FIG. 9 is a graph depicting bottom sag resistance test results.

### DETAILED DESCRIPTION

Described below are embodiments of an adhesive-coated reinforcing tape or string, and containers or reinforced constructs (e.g., a container blank) that are reinforced with the tape or string. Generally, the tape or string can be applied to a substrate of a container during manufacturing of the substrate. Alternatively, the tape or string can be applied to containers after the containers have been formed or folded and glued into a finished container (i.e., a post-manufacturing step).

The reinforcing tape or string may improve the container performance while potentially lowering the container cost. For example, reinforcing tape or string may allow for lower liner and/or corrugated board weight (which lowers cost), thereby lowering the cost of the corrugated member arrangement, and/or decrease the overall incident rate of container failure.

In certain embodiments, the reinforcing tape or string is oriented parallel to the length direction of the container and perpendicular to the flute direction of the corrugated paper board of the container. In other words, in this embodiment the flute direction is parallel to the width direction of the container.

It has presently been determined that on control containers that do not include reinforcing tape or string, flutes running in the length direction of a container provide more resistance to bottom sag compared to unreinforced control containers with flutes running in the width direction. However, it has now been surprisingly discovered that superior bottom sag resistance may be obtained when the reinforcing tape or string is oriented parallel to the length direction of the container, and perpendicular to the flute direction of the corrugated paper board of the container (i.e., the flute direction is parallel to the width direction of the container). The bottom sag resistance in containers with the parallel container length/perpendicular flute direction orientation may be significantly improved compared to the control containers (i.e., do not include reinforcing tape or string) having a flute direction parallel to the length direction of the container. Test results indicate that improved bottom sag resistance is due to a synergistic interaction between the reinforcing tape or string direction and the flute direction.

A reinforcing tape or string typically is applied to a substrate to reinforce stress points in the end product (e.g., a formed or finished carton or box) produced or formed from the substrate. In this context, a reinforcing tape differs from a package sealing tape that is used only to seal the opening, panels or flaps of a container or box. Container stress points that are typically reinforced are those that have weak points or areas subject to stress that occurs in container handling or filling. Examples of specific stress points include hand holes, access holes, handles, basiloid lifting areas, scorelines (e.g., corner or horizontal scorelines or vertical scorelines), and similar areas that are subject to tears or structural failure (which may lead to container stack collapse). Moreover, reinforcing tape or string may be added during the board manufacturing process as described below in more detail.

In certain embodiments disclosed herein, the reinforcing tape or string is located so as to prevent or minimize bottom sag. As used herein, “bottom sag” refers to the deflection growth over time of the bottom panel of a loaded container.

The reinforcing tape or string can be made of an adhesive disposed on a substrate. The substrate may be a fibrous material or a non-fibrous material such as a polymeric film. The fibrous material may be in the form of a woven or nonwoven web, a fiber-reinforced film, a fiber bundle, a monofilament, or any combination thereof. Examples of fiber bundles include multifilament yarns, which may or may not be unidirectionally oriented. A tape typically has a flattened cross-section. A string typically has a round cross-section. An illustrative example of a fibrous material is a unidirectionally-oriented, multifilament fiber bundle that is at least partially twisted or entangled to impart cohesion to the fiber bundle.

The fibrous material can be any material that is characterized by sufficiently high tensile modulus and tensile strength properties suitable for providing the desired degree of reinforcement. Examples of such materials include liquid crystal polymer fiber (e.g., Vectran® fiber available from Kuraray), aromatic polyamide fiber (e.g., Kevlar® fiber from E.I. du Pont or Twaron® fiber available from Teijin Aramid), carbon fiber, polyetheretherketone fiber, and/or other similar materials. In certain embodiments, fiberglass is not a suitable reinforcing fibrous material.

The fibrous material is coated (e.g., impregnated) with at least one adhesive. Generally, the adhesive of the reinforcing tape or string is configured to facilitate secure attachment of the tape or string to a container substrate. In some embodiments, the adhesive can be a hot melt adhesive including, but not limited to, a heat activatable hot melt adhesive, a hot melt pressure sensitive adhesive, a hot melt remoistenable adhesive, a water dispersible hot melt adhesive, a biodegradable hot melt adhesive or a repulpable hot melt adhesive. Examples of typical hot melt adhesives include an ethylene-vinyl acetate copolymer (EVA-based) hot melt adhesive; EMA-based hot melt adhesive (ethylene methylacrylate); EnBA-based hot melt adhesive (ethylene n-butyl acrylate); hot melt adhesive based on polyamides; hot melt remoistenable adhesive based on polyamides and copolyesters; hot melt adhesives based on polyethylene and polypropylene homopolymers, copolymers and interpolymers, rubbery block copolymer hot melt adhesives; or RF (radio frequency) activatable adhesives. Other types of tapes such as organic solvent adhesives, water-based adhesives, or pressure sensitive adhesives may be used.

In one embodiment, the reinforcing tape may be a tape that includes multiple continuous strands of high tensile modulus strength filaments, particularly liquid crystal polymer (“LCP) fibers, coated with a heat activatable hot melt adhesive. It has been discovered that LCP fibers are compatible with hot melt adhesives. For example, the bond strength between the heat activatable hot melt adhesive and the LCP fibers has been determined by testing to be sufficient for container reinforcing requirements. In addition, the LCP fibers have a sufficiently high melting point to withstand the temperatures at which the molten hot melt adhesive is applied to the fibers. In certain embodiments, the LCP fibers have a melt point of at least 180° C.

In some implementations, the adhesive-coated tape or adhesive-coated string has a chord modulus between 0 and 4% elongation of at least 100 grams/denier, more particularly at least 200 grams/denier, most particularly at least 250 grams/denier, and even more particularly at least 270 grams/denier, as measured on the adhesive-coated tape or adhesive-coated string. In certain embodiments, the adhesive-coated tape or adhesive-coated string has a tensile strength of at least 15 lb, more particularly at least 50 lb, and most particularly at least 90 lb, as measured on the adhesive-coated tape or adhesive-coated string.

The high tensile modulus fibrous materials also are higher in strength for a given fiber mass relative to prior art reinforcing tapes. In applications where breaking strength is a concern, the high tensile modulus fibrous materials can provide the desired performance with significantly decreased volume of reinforcement (fiber and adhesive). There will be less disruption in the corrugated structure with a narrow thin tape than a wider tape. Thus, in one example, the combined amount of adhesive and fibrous material in any individual tape or string is sufficient to provide the desired reinforcing properties. In certain embodiments, the reinforcing tape or string may have a basis weight of 0.2 to 1.0, more particularly 0.4 to 0.5, and most particularly 0.40 to 0.45, g/linear m. In certain embodiments, the reinforcing tape or string may have a thickness of 0.10 to 0.22 mm, more particularly 0.17 to 0.20 mm, prior to adhesion to the corrugated paper board. After adhesion to the corrugated paper board, the reinforcing tape or string may have a thickness of 0.04 to 0.11 mm, more particularly 0.07 to 0.10 mm. In some embodiments, reinforcing tape or string can have a length longer than its width. In other words, the reinforcing tape or string defines a longitudinal axis along a longitudinal direction. In specific embodiments, the width is less than or equal to 10 mm, more particularly less than or equal to 8 mm, most particularly less than or equal to 5 mm. In certain embodiments, the tape has a width of 2 mm to 10 mm, more particularly 2 min to 4 mm, and most particularly 2 to 3 mm.

The reinforcing tape or string provides a higher resistance to deformation at a specific deformation rate. Since corrugated paper board typically has a breaking elongation of 1-4%, the reinforcing tape or string matched to the corrugated paper board elongation may provide better load sharing, and the load resistance at these relatively low elongations may be realized in the reinforced container with significantly less deformation. Moreover, corrugated paper board continues to deform over time. This time-dependent deformation is referred to as “creep.” By utilizing a reinforcing tape or string that has a lower creep or rate of deformation compared to the creep or rate of deformation of the corrugated paper board, deformation of the corrugated paper board can be minimized or prevented. For example, in certain embodiments the tape or string retains at least 50%, more particularly at least 60%, and most particularly at least 75%, of its tensile strength at 3% deformation.

By limiting the initial deformation during the container loading and slowing the deformation growth rate of the loaded container, the overall performance is improved and the benefit increases the longer the containers remain loaded. In the case of a fruit tray, this equates to less bottom sag. The longer the fruit is in storage, less fruit is damaged on the bottom layers since the weight is supported by the tray instead of the fruit beneath it. In bulk bins this would reduce the bulge or “elephant footing” as a full bin sits in a warehouse over time. The service life of the bin is therefore improved and the ability to contain/protect the contents is also improved.

As described above, the reinforcing tape or string can be applied to a substrate to reinforce the substrate and a container formed at least in part from the substrate. The substrate may be a corrugated paper board having a predetermined flute direction. The corrugated paper board may be a single wall structure (i.e., includes a single fluted corrugated medium and at least one liner layer) or a multiwall structure (i.e., includes at least two fluted corrugated mediums and at least one liner layer). One or more substrates can form an article of manufacture such as a packaging container. Examples of packaging containers include cartons and boxes, such as cartons for holding beverages for sale at the retail level (for instance, a hand-carry carton that holds six, 12 or 24 bottles or cans of a beverage), meat and produce bulk bins, wet-packed containers, reusable containers, rubber and chemical bulk bins, and heavy duty containers. In certain embodiments, the packaging container includes a bottom and four walls, but no top. For example, produce (e.g., fruit) trays for storing and shipping fruit or other produce typically are open at the top and have a single, continuous, seamless panel forming the bottom of the fruit tray.

Currently, there is no suitable reinforcement to prevent bottom sag in produce trays. Polyester-based reinforcement tapes exhibit too much elongation at the standard loading of a produce tray. It would require too much volume of polyester tape reinforcement to prevent the sag economically. The reinforcement has to be able to resist creep of up to 2% to meet the demands of fruit tray bottom sag. Polyester reinforcement tapes have insufficient strength retention at 2% strain to perform well in bottom sag resistance. Fiberglass tapes have issues with breaking when bent and tend to lose strength and effectiveness in the application. This problem would be magnified in a production environment and would cause inconsistent results due to varying degrees of fiber breakage. The presently disclosed high tensile modulus tapes or strings with creep resistance can meet the demands of this application with less mass and no issues with fiber breakage.

Another illustrative use for the presently disclosed high tensile modulus tapes or strings is for reinforcing bulk bins. The reinforced bulk bins are more burst resistant, more resistant to bulge and have better stacking strength. Other illustrative uses include, but are not limited to, E flute corrugated paper board, corrugated using preprint, and two tape container opening systems to prevent leaning in a container stack.

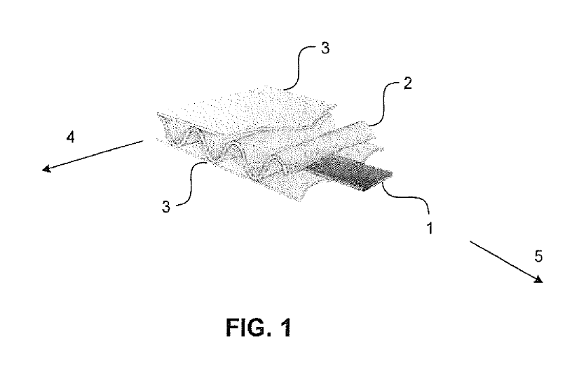

The reinforcing tape or string may be embedded within the corrugated paper board substrate or applied to the surface of an outer layer of the corrugated paper board substrate. In certain embodiments, the reinforcing tape or string is disposed between the corrugated flute member and an exterior liner that forms the outside surface of the container. In other embodiments, the reinforcing tape or string is disposed between the corrugated flute member and an interior liner that forms the inside surface of the container. FIG. 1 illustrates an embodiment wherein the longitudinal direction 5 of the reinforcing tape 1 is oriented perpendicular to the flute direction 4 and the reinforcing tape is disposed between a corrugated flute member 2 and a liner 3.

As described above, the reinforcing tape or string is located in and/or on the container in a position to achieve the desired reinforcement. For example, the reinforcing tape or string is positioned to prevent or minimize bottom sag of a container, particularly a produce (e.g. fruit) tray. The reinforcing tape or string may be located at any position, but it has been discovered that certain tape orientations may provide superior bottom sag resistance. In particular, superior bottom sag resistance may be obtained when the longitudinal direction of the reinforcing tape or string is oriented parallel to the length direction of the container, but perpendicular to the flute direction of the corrugated paper board of the container (i.e., the flute direction is parallel to the width direction of the container). However, in certain embodiments, the longitudinal direction of the reinforcing tape or string may be oriented parallel to the flute direction. In other embodiments, the longitudinal direction of the reinforcing tape or string may be oriented in the width direction of the container. The reinforcing tape or string preferably extends across the entire length or width of the container, but in certain embodiments the reinforcing tape or string may extend across a portion of the length or width of the container that is less than the entire length or width of the container.

In certain embodiments, there may be more than one reinforcing tape or string applied to a container. For example, there may be a plurality of reinforcing tapes or strings applied in the length direction of the container. In another embodiment, there may be one or more reinforcing tapes applied in the length direction of the container, and one or more reinforcing tapes applied in the width direction of the container.

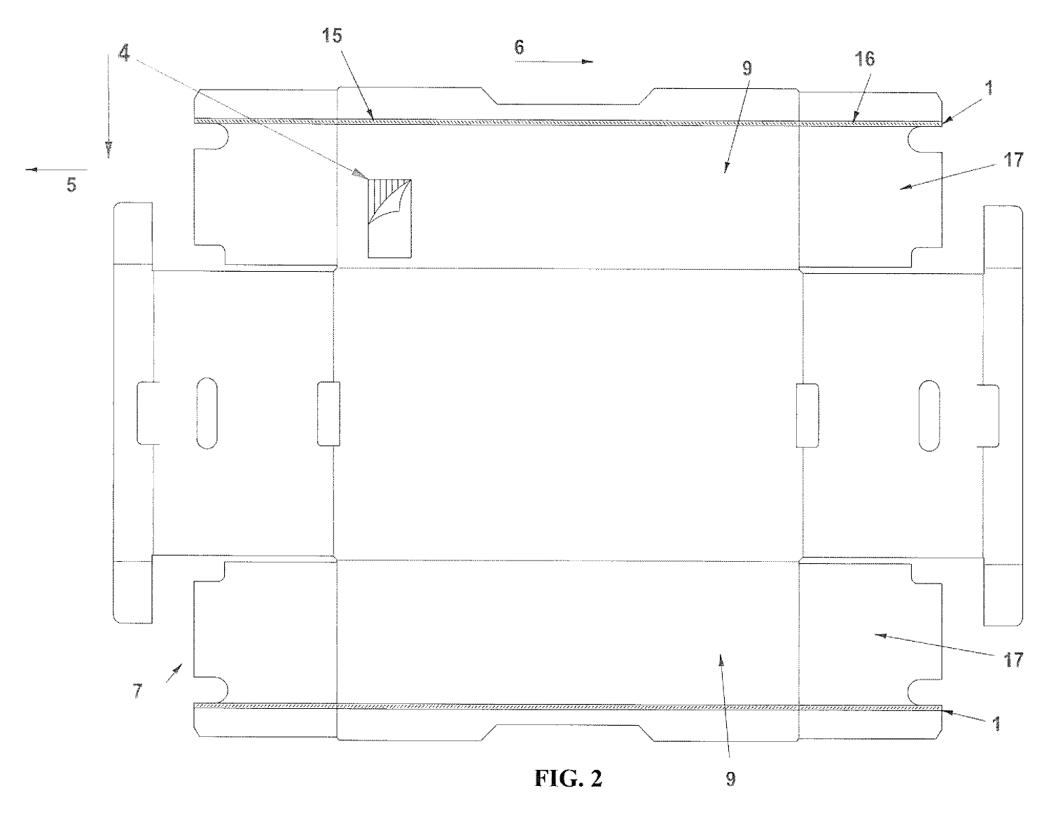

Illustrative examples of locations for the reinforcing tape or string are shown in FIGS. 2-7. The container embodiments shown in FIG. 2-7 are fruit trays that include a bottom panel that consists of a single, continuous, seamless panel, but do not include a top panel. However, the location(s) and orientations of the tapes shown in FIG. 2-7 are also applicable to other types of containers.

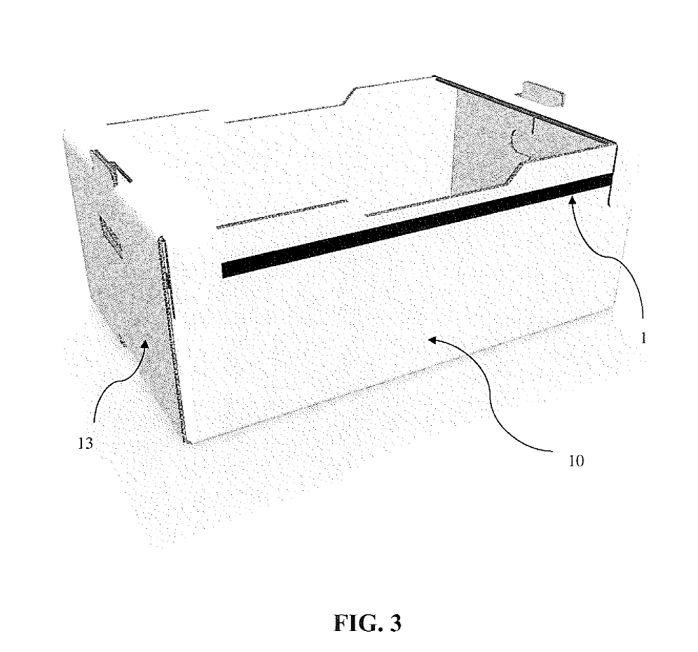

FIGS. 2 and 3 illustrate an embodiment in which there are two reinforcement tapes I having a longitudinal direction 5 oriented parallel to the length direction 6 of a container blank 7 (FIG. 2) or container 8 (FIG. 3). The longitudinal direction 5 of each of the tapes 1 is oriented perpendicular to the flute direction 4. The flutes and the flute direction 4 are shown in a cut-out view box in FIG. 2. A first section 15 of a single tape 1 is embedded within, or adhesively affixed to a surface (interior or exterior) of each length side flap 9 (FIG. 2) or each length side wall 10 (FIG. 3). A second section 16 of tape 1 is embedded within, or adhesively affixed to a surface (interior or exterior) of, a flap 17 that forms a portion of the width side wall of the container. Thus, tape 1 wraps around a corner of the container. In certain embodiments, only one of the length side flap 9 or wall 10 includes a reinforcing tape 1. In other embodiments, each length side flap 9 or wall 10 includes more than one reinforcing tape. In the embodiment shown in FIGS. 2 and 3, the reinforcing tapes extends along the entire length of the container, but in certain embodiments the reinforcing tape may extend along only a portion of the length of the container that is less than the entire length.

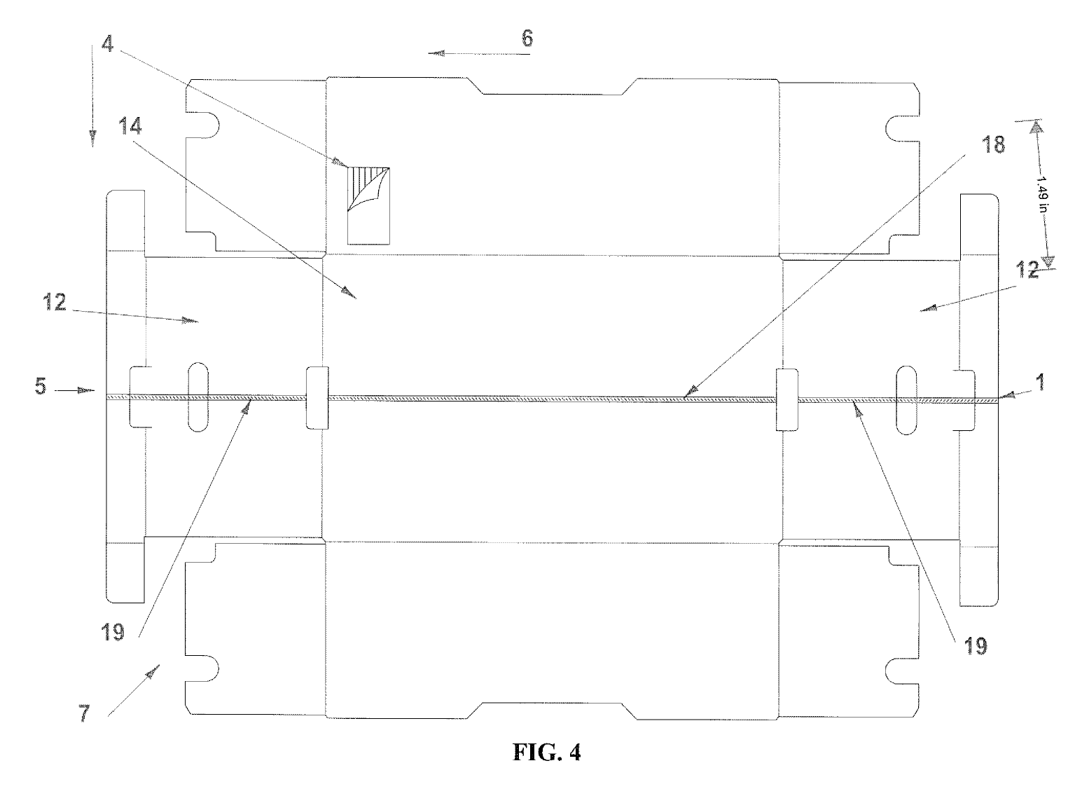

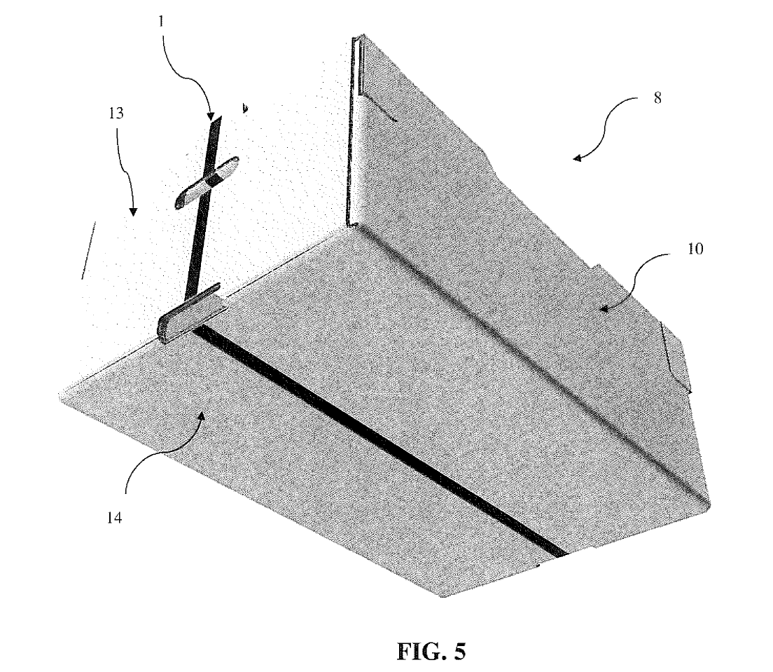

FIGS. 4 and 5 illustrate another embodiment in which there is a single reinforcement tape 1 having a longitudinal direction 5 oriented parallel to the length direction 6 of a container blank 7 (FIG. 4) or a container 8 (FIG. 5). The longitudinal direction 5 of the tape 1 is oriented perpendicular to the flute direction 4. The flutes and the flute direction 4 are shown in a cut-out view box in FIG. 4. A first section 18 of a single tape 1 is embedded within, or adhesively affixed to a surface (interior or exterior) of, a bottom panel 14. A second section 19 of the tape 1 is embedded within, or adhesively affixed to a surface (interior or exterior) of, a width side flap 12 that forms the width side wall 13. Thus, tape 1 wraps around a bottom edge of the container. In certain embodiments, there may be more than one reinforcing tape extending along the bottom panel 14. In the embodiment shown in FIGS. 4 and 5, the reinforcing tape extends along the entire length of the container, but in certain embodiments the reinforcing tape may extend along only a portion of the length of the container that is less than the entire length.

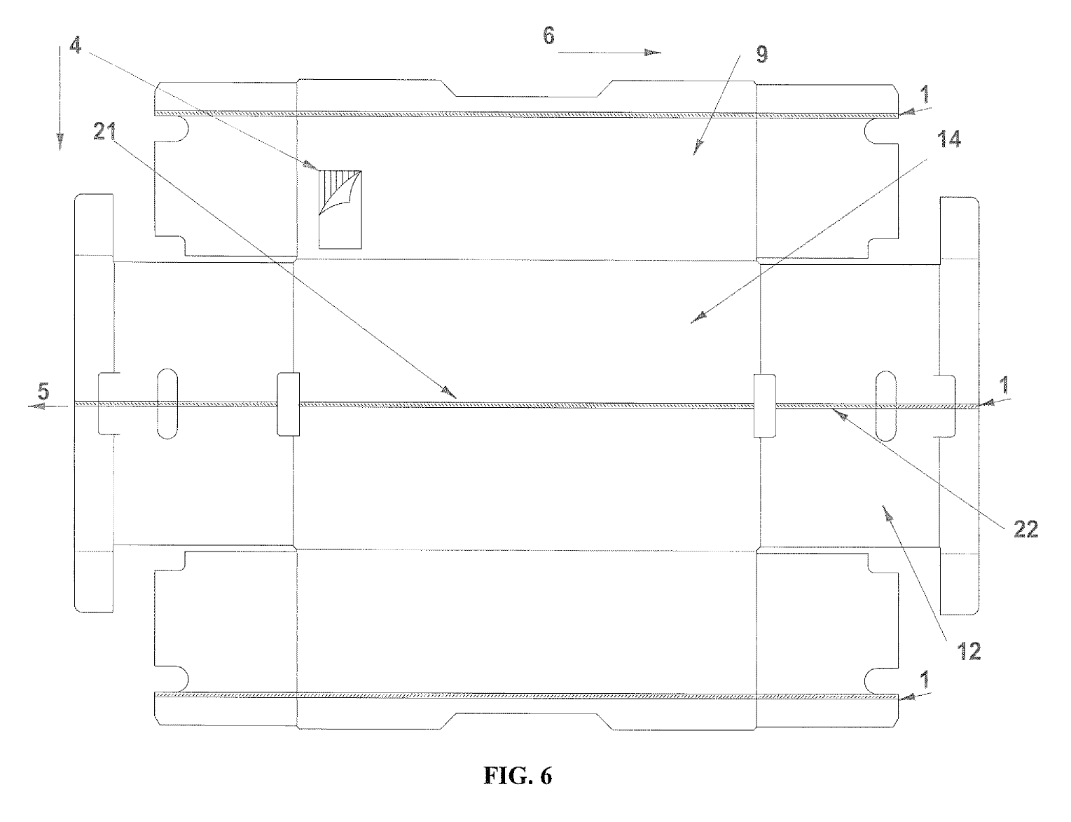

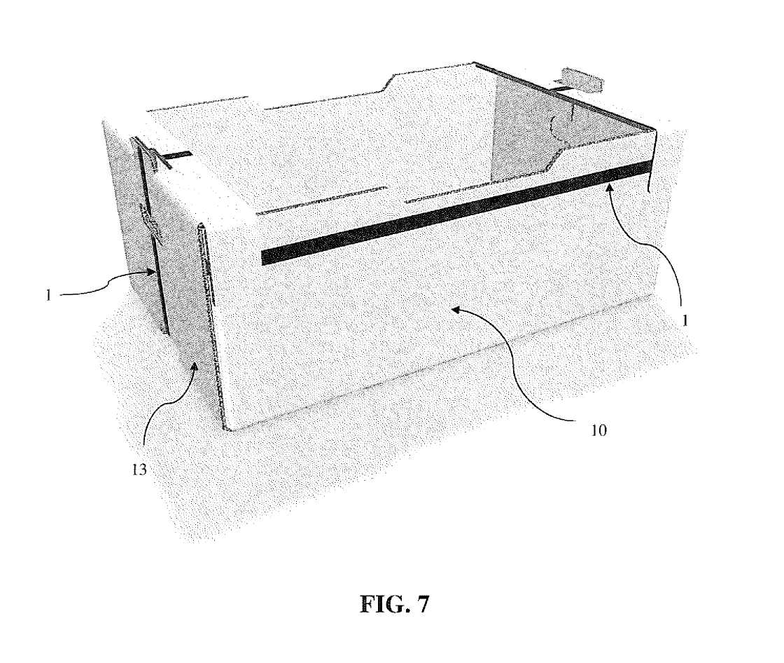

FIGS. 6 and 7 illustrate an embodiment in which there are three reinforcement tapes 1 having a longitudinal direction 5 oriented parallel to the length direction 6 of a container blank 7 (FIG. 6) or container 8 (FIG. 7). The longitudinal direction 5 of each of the tapes 1 is oriented perpendicular to the flute direction 4. The flutes and the flute direction 4 are shown in a cut-out view box in FIG. 6. A single tape 1 is embedded within, or adhesively affixed to a surface (interior or exterior) of, each length side flap 9 (FIG. 6) or each length side wall 10 (FIG. 7). In addition, there is a single reinforcement tape 1 embedded within, or adhesively affixed to a surface (interior or exterior) of, a bottom panel 14. In this embodiment a first section 21 of the reinforcing tape 1 is arranged on the bottom panel 14, and a second section 22 the reinforcing tape 1 arranged on the bottom panel 14 extends in a vertical direction along the width side flap 12 or wall 13. Thus, tape 1 wraps around a corner of the container. In certain embodiments, there may be only a reinforcing tape(s) arranged on the bottom panel (i.e., there are no reinforcing tapes arranged on the length side flap 9 or length side wall 10). In the embodiment shown in FIGS. 6 and 7, the reinforcing tapes extends along the entire length of the container, but in certain embodiments the reinforcing tape may extend along only a portion of the length of the container that is less than the entire length.

One embodiment of a reinforced construct disclosed herein is a continuous corrugated board substrate. The continuous corrugated board substrate includes an exterior liner and a corrugated member. In some implementations, the corrugated member consists of a series of parallel flutes. However, in other implementations, the corrugated member can include other configurations, such as a waffle-type pattern or honeycomb.

The continuous corrugated board substrate can be manufactured by bonding the corrugated member to the exterior liner using an adhesive, such as a heat-activated adhesive, and subjecting the exterior liner and corrugated member to heat.

The substrate can be reinforced during its manufacture by continuously feeding reinforcing tape or string between the corrugated member and the exterior liner of the substrate prior to bonding the exterior liner to the corrugated member. As described above, the reinforcing tape or string includes an adhesive, such as a heat-activated adhesive, which is activated as the substrate is passed through a heat station to bond the reinforcing tape with the liner and/or the corrugated member. For example, the heat typically applied to a corrugator production line (e.g., via steam blowers) activates the hot melt adhesive and bonds the fibrous material of the reinforcing tape or string to the liner and/or corrugated member. In one illustrative embodiment, the exterior liner, reinforcing tape or string and corrugated layer are at least partially pressed together by a roller and heat is applied to the combination of layers to bond the layers to each other to form the corrugated board substrate. The pressure applied by the roller is sufficient to achieve the desired bonding and may vary widely. The level of applied heat is sufficient to achieve the desired bonding and may vary widely. An illustrative range of applied heat is about 80 to about 120° C. The application of heat activates the adhesive of the reinforcing tape or string to bond it to the exterior liner, corrugated layer or both depending on the application of the adhesive and orientation of the reinforcing tape or string. Further, the exterior liner and/or corrugated layer can have a coating of heat-activated adhesive applied thereto prior to passing through the roller. The application of heat then activates the adhesive to bond the exterior liner and/or corrugated layer to the reinforcing tape or string.

In this way, a substrate can be formed having reinforcing tape or string embedded in the substrate, i.e., incorporation or insertion between layers of a substrate (e.g., between the substrate liner and the corrugated member). The continuous corrugated board substrate with embedded reinforcing tape or string may then be scored and cut into individual corrugated board blanks.

In some embodiments, the corrugated board substrate can also include an interior liner such that the corrugated member is at least partially positioned between the exterior liner and the interior liner. The interior liner could be applied to the corrugated member in a manner similar to that of the exterior liner as described above. The reinforcing tape or string can be applied to the substrate such that it is positioned between the interior liner and the corrugated member.

The reinforcing tape or string may be applied to the continuous corrugated board at any production line speed. For illustrative purposes, the reinforcing tape or string can be applied to the continuous corrugated board at production line speeds of 152-450 meters/minute, or at production line speeds of at least about 213 meters/minute.

Any apparatus or system may be used to apply the reinforcing tape or string to the corrugated board. A typical system is a Tape Dispenser Model V and Universal Beam tape applicator commercially available from Adalis Corporation, An H.B. Fuller Company, of Vancouver, Wash.

In another embodiment, a folding container substrate is a pre-cut, pre-formed individual folding container blank produced prior to application of reinforcing tape or string onto the substrate. The folding container substrate can be any applicable substrate that can be used to form a container or carton. However, the application of reinforcing tape or string on non-continuous substrate is not limited to folding carton, but can be applied to any type of non-continuous substrate such as non-continuous corrugated blanks.

The folding container substrate, e.g., an individual folding carton blank, can be reinforced by cutting a length of reinforcing tape or string from a roll and applying the length onto a surface of the folding carton blank. The reinforcing tape or string includes an adhesive, such as a heat-activated adhesive or a pressure sensitive adhesive that bonds the reinforcing tape to the folding container blank. The reinforcing tape or string may be applied to the folding carton blanks at any production line speed. For illustrative purposes, the reinforcing tape or string can be applied to the folding carton blanks at production line speeds of between 300-1,200 feet/minute, or at production line speeds of 12,500 to 50,000 carton blanks/minute.

### EXAMPLE

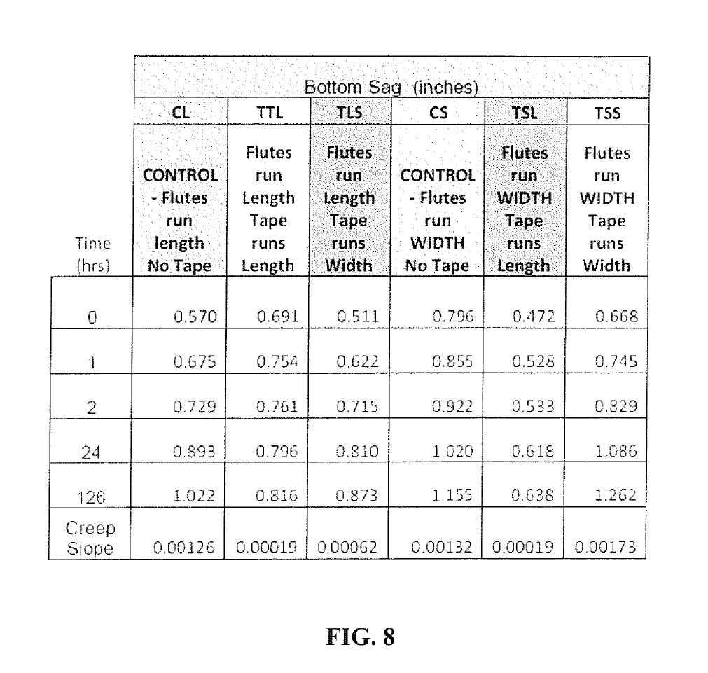

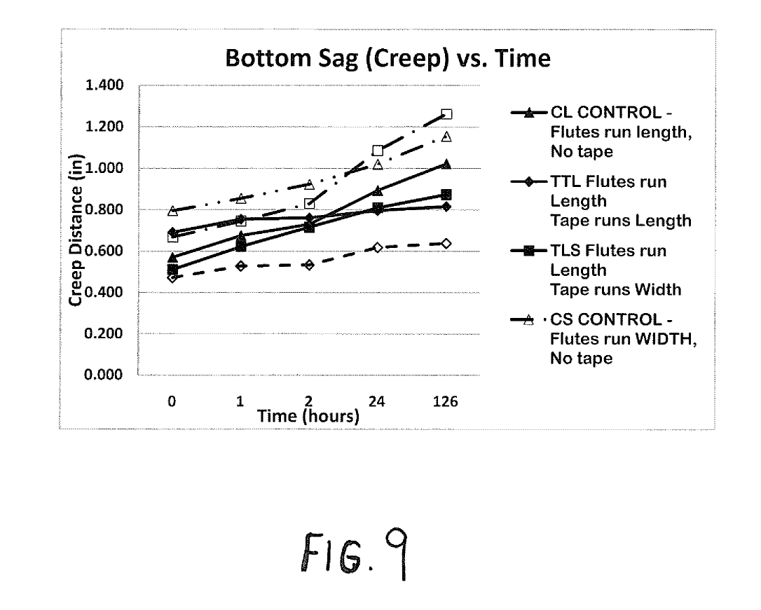

Bottom sag testing was performed on single wall corrugated fruit trays. Reinforcing tape that includes LCP fibers (Vectran® fibers) and a hot melt adhesive was used. The trays were filled with 35 pounds of material and placed in an environmental control chamber. The trays are held (suspended by the ends) on a test stand that includes bars mounted beneath the suspended trays. The bars hold dial indicator meters that measure the displacement of the bottom panel of the trays. There meters were read by people at certain time intervals. The results are shown in FIGS. 8 and 9. It is clear from the data shown in FIGS. 8 and 9 that an embodiment in which the reinforcing tape is oriented parallel to the length direction of the container and perpendicular to the flute direction provided the best bottom sag resistance over time.

In view of the many possible embodiments to which the principles of the disclosed articles and methods may be applied, it should be recognized that the illustrated embodiments are only preferred examples and should not be taken as limiting the scope of the invention.

What is claimed is:

1. A container comprising:
at least one panel or flap configured to at least partially form a bottom or at least one wall of the container, wherein the panel or flap comprises a corrugated paper board, and the panel or flap includes an inside surface and an outside surface; and
at least one reinforcing tape or string adhesively affixed to at least one panel or flap of the container, wherein the reinforcing tape or string comprises an adhesive disposed on a substrate, the reinforcing tape or string has a chord modulus of at least 100 grams/denier between 0% and 4% elongation, and the reinforcing tape or string has a width of equal to or less than 10 mm.

2. The container of claim 1, wherein the corrugated paper board has a flute direction, the reinforcing tape or string has a longitudinal direction, and the reinforcing tape or string is located so that the longitudinal direction of the reinforcing tape or string is perpendicular to the flute direction of the corrugated paper board.

3. The container of claim 1, wherein the container has a length direction that is longer than a width direction, the reinforcing tape or string has a longitudinal direction, and the longitudinal direction of the reinforcing tape or string is parallel to the length direction of the packaging container.

4. The container of claim 2, wherein the container has a length direction that is longer than a width direction, and the longitudinal direction of the reinforcing tape or string is parallel to the length direction of the packaging container.

5. The container of claim 1, wherein the substrate is a fibrous material.

6. The container of claim 1, wherein the container has a bottom and four side walls, but no top.

7. The container of claim 1, wherein the bottom of the container consists of a single, continuous, seamless panel.

8. The container of claim 1, wherein the container is a produce tray.

9. The container of claim 1, wherein the reinforcing tape or string retains at least 50% of its tensile strength at 3% deformation.

10. The container of claim 1, wherein the reinforcing tape or string has a lower rate of deformation than the rate of deformation of the corrugated paper board.

11. The container of claim 1, wherein the reinforcing tape or string has a basis weight of 0.2 to 1.0 g/linear m.

12. The container of claim 5, wherein the fibrous material comprises liquid crystal polymer fibers and the adhesive comprises a hot melt adhesive. 20

13. The container of claim 4, wherein the reinforcing tape or string retains at least 50% of its tensile strength at 3% deformation, the reinforcing tape or string has a lower rate of deformation than the rate of deformation of the corrugated paper board, the reinforcing tape or string has a basis weight of 0.2 to 1.0 g/linear in, and the reinforcing tape or string has a chord modulus of at least 200 grams/denier between 0% and 4% elongation.

14. The container of claim 13, wherein the substrate comprises liquid crystal polymer fibers and the adhesive comprises a hot melt adhesive.

15. The container of claim 1, wherein the reinforcing tape or string is disposed within the corrugated paper board.

16. A container comprising:
at least one panel or flap configured to at least partially form a bottom or at least one wall of the container, wherein the panel or flap comprises a corrugated paper board, and the panel or flap includes an inside surface and an outside surface; and
at least one reinforcing tape or string adhesively affixed within the corrugated paper board forming the bottom panel of the container, wherein the reinforcing tape or string comprises a hot melt adhesive disposed on a liquid crystal polymer fibrous material, and the reinforcing tape or string has a chord modulus of at least 200 grams/denier between 0% and 4% elongation.

17. A reinforced construct, comprising:
a corrugated paper board substrate having a flute direction and comprising at least a first layer and at least a second layer; and
a reinforcing tape or string adhesively secured to at least the first layer or the second layer, wherein the reinforcing tape or string has a longitudinal direction and the reinforcing tape or string is located so that the longitudinal direction of the reinforcing tape or string is perpendicular to the flute direction of the corrugated paper board, wherein the reinforcing tape or string comprises an adhesive disposed on a substrate, the reinforcing tape or string has a chord modulus of at least 100 grams/denier between 0% and 4% elongation, and the reinforcing tape or string has a width of equal to or less than 10 mm.

18. The construct of claim 17, wherein the construct comprises a container blank.

19. The construct of claim 17, wherein the substrate comprises liquid crystal polymer fibers and the adhesive comprises a hot melt adhesive.

20. The construct of claim 19, wherein the reinforcing tape or string retains at least 50% of its tensile strength at 3% deformation, the reinforcing tape or string has a lower rate of deformation than the rate of deformation of the corrugated paper board, the reinforcing tape or string has a basis weight of 0.2 to 1.0 g/linear in, and the reinforcing tape or string has a chord modulus of at least 200 grams/denier between 0% and 4% elongation.

21. The construct of claim 17, wherein the reinforcing tape or string is embedded between the first layer and the second layer of corrugated paper board substrate.

22. A reinforcing tape or string, comprising:
a length of elongate, hot melt adhesive-coated liquid crystal polymer fibrous material, wherein the reinforcing tape or string has a width of equal to or less than 10 mm.

23. The tape or string of claim 22, wherein the reinforcing tape or string has a chord modulus of at least 200 grams/denier between 0% and 4% elongation, retains at least 50% of its tensile strength at 3% deformation, and has a basis weight of 0.2 to 1.0 g/linear m.

24. A method for minimizing or preventing sagging of a corrugated paper board bottom panel of a container, wherein the corrugated paper board bottom panel has a flute direction and a length direction that is longer than a width direction, the method comprising:
providing a reinforcing tape or string along the length direction of the corrugated paper board bottom panel and in a longitudinal direction perpendicular to the flute direction of the corrugated paper board bottom panel, wherein the reinforcing tape or string comprises an adhesive disposed on a substrate, the reinforcing tape or string has a chord modulus of at least 200 grams/denier between 0% and 4% elongation, and the reinforcing tape or string has a width of equal to or less than 10 mm.

25. A method for minimizing or preventing deflection of a corrugated paper board side wall of a container, wherein the corrugated paper board side wall has a flute direction, the method comprising:
providing a reinforcing tape or string in a longitudinal direction perpendicular to the flute direction of the corrugated paper board side wall, wherein the reinforcing tape or string comprises an adhesive disposed on a substrate, the reinforcing tape or string has a chord modulus of at least 200 grams/denier between 0% and 4% elongation, and the reinforcing tape or string has a width of equal to or less than 10 mm.
